(19) United States
(12) Patent Application Publication
(10) Pub. No.: US 2001/0056479 A1
(43) Pub. Date: Dec. 27, 2001

(54) Voice searching system of internet information to be used for cellular phone

(75) Inventors: Naoyuki Miyayama, Tokyo (JP); Yoshinobu Yamane, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Naoyuki MIYAYAMA, Tokyo (JP)

(21) Appl. No.: 09/860,448

(22) Filed: May 21, 2001

(30) Foreign Application Priority Data
May 17, 2000 (JP) JP2000-144504
Aug. 28, 2000 (JP) JP2000-257541

(51) Int. Cl. G06F 15/16

(52) U.S. Cl. 709/219; 709/206

(57) ABSTRACT

It is an object of the present invention to provide a searching system of an internet information for a cellular phone, in which an input operation of the searched information or the like is easy. The searching system of an internet information for a cellular phone is composed of a cellular phone receiving unit 61 for receiving the telephone call from the cellular phone terminal 1 to be connected through the cellular phone telephone network 3, a voice response apparatus 62 for transmitting a guide voice by a synthetic voice to the cellular phone terminal 1, a voice recognition apparatus 63 for voice recognizing the voice phone call to be transmitted from the cellular phone terminal 1 and converting it to data information, a searched information data base 64, which stores various information to be searched in a predetermined data format, an information searching for processing unit 65 for searching a desired information by having access to the searched information data base 64 on the basis of a content of converted text data information and a searched information transmitting server 66 for transmitting the obtained searching result in an electric mail to the cellular phone terminal 1 in a predetermined format such as an electric mail, an image and a voice or the like through the internet network 4.

### BACKGROUND OF THE INVENTION

1. Field of the Invention

The present invention relates to a voice searching system of internet information for a cellular phone, which is provided with an internet function. More particularly, the present invention relates to a voice searching system of an internet information for a cellular phone for obtaining the information in such a manner that necessary information is automatically searched for on the basis of the searching request by using a voice through a telephone line from the cellular phone terminal and the obtained searching result is transmitted by the transmission of the electric mail or the URL of the Web via an electric mail to the cellular phone terminal through the internet in a desired format such as characteristic information, an image, a voice or the like.

2. Description of the Prior Art

With the development of a mobile technology in recent years, the cellular phone, which is provided with an internet function, for example, imode (carrier: NTT DoCoMo group), EZweb (carrier: Tu-Ka Cellular group) and J-SKY web (carrier: J-PHONE group) or the like, has been widely diffused. Such a cellular phone with an internet function has been providing various internet service functions, for example, a booking service of a ticket of an air line ticket and a train ticket and the information concerning the congestion thereof, a booking service of a ticket of a cinema and a play and information concerning the opening thereof and the information for reserving an inn and a hotel and concerning the availability thereof or the like, for value or for free.

In order to obtain necessary information by having access to an internet service from a cellular phone terminal provided with such an internet function, following methods are employed in general. Namely, taking an example such that an accommodation, which fits the requirements, is searched by having access to a site for providing information for reserving an inn and a hotel and concerning the availability thereof to explain the method, at first, an internet mode key, which is prepared on the cellular phone terminal, is pressed. Hereby, the cellular phone is connected to an internet service center of the carrier of this cellular phone, so that a top page of the internet service is displayed on a screen of the cellular phone terminal.

If the user of the cellular phone selects an item to proceed to a service of his or her choice from the top page displayed on the screen, for example, if the user selects a “menu”, a menu list screen is displayed. Then, the user selects a category of the information the one wants from this menu list, for example, a “travel”. If a travel information screen is displayed, various information items in association with travel are displayed on this travel information screen, so that the user selects a searching item for searching the information one wants from this menu list, for example, “accommodation search”. This allows the cellular phone terminal to be connected to a server of an internet information provider (IP) for providing the current service through a leased line or a normal internet network from the internet service center. As a result, the intended accommodation searching screen is displayed on the cellular phone terminal.

If the user clicks a search start icon on the screen after inputting necessary information piece such as an stay area, an expected date for stay, an accommodation charge, a class of a hotel and a type of a room, i.e., a twin bedroom, a double bedroom or the like in accordance with the instruction on the screen, the search will be started. Then, when the search is completed, its search result will be transmitted to the cellular phone terminal and a necessary piece of information such as a name, an address, a telephone number and a URL (a home page address) or the like of an inn or a hotel, which satisfy the searching condition, is displayed on the screen of the terminal. Then, the user telephones the inn or the hotel, which is displayed on the screen, by using a function, “phone to” or the like to reserve a hotel.

### SUMMARY OF THE INVENTION

As being obvious from the above description, a user of a cellular phone obtains a piece of necessary information according to an information search for the use of an internet function in such a manner that a necessary searching condition is inputted after reaching the intended searching screen by proceeding to a deeper layer step by step while sequentially selecting an item to be displayed in sequence on the screen of the cellular phone terminal hierarchical-structurally with the operation such as the icon scrolling or the like.

However, in the case of the searching method for the use of these hierarchical structures and the changing of the screen, there are many searching objects, so that this method involved a problem such that much trouble and considerable time were required to reach the intended searching screen. Therefore, for the user who is not used to using the cellular phone terminal, the operation thereof was too difficult to reach an intended searching screen. Even if the one reached the intended searching screen, much trouble and considerable time were required to input the searching condition or the like, so that this method was very inconvenient for the user.

The present invention has been made taking the problems into consideration, an object of which is to provide a voice searching system of an internet information for a cellular phone terminal, in which the input of the searched information or the like is very easy and which is very easy to handle, for collecting the searched information by the voice recognition through a normal cellular phone line and transmitting the obtained searching result by the transmission of the electric mail or the URL of the Web via an electric mail to the cellular phone terminal through the internet network in a desired format such as a characteristic information, an image, a voice or the like so as to obtain the information.

In order to attain the above described purpose, a voice searching system of an internet information for a cellular phone according to the present invention comprises cellular phone receiving means for receiving a telephone call from a cellular phone terminal to be connected through a cellular phone telephone network, voice response means for transmitting a guide voice to the cellular phone terminal, means for voice recognizing the voice phone call to be transmitted from the cellular phone and searching for desired data information, a searched information data base, which stores various information to be searched in a predetermined data format, information searching processing unit for searching for desired information by having access to the searched information data base on the basis of the contents of the collected data information, and searched information transmitting server for automatically transmitting the obtained search result to the cellular phone terminal through an internet network via an electric mail in a predetermined format such as a characteristic information, an image and a voice or the like.

Alternatively, the voice searching system of the internet information for the cellular phone terminal according to the present invention comprises cellular phone receiving means for receiving a telephone call from a cellular phone terminal to be connected through a cellular phone telephone network, voice response means for transmitting a guide voice by the voice to the cellular phone terminal, means for voice recognizing the voice phone call to be transmitted from the cellular phone terminal and searching for desired data information, a searched information data base, which stores various information to be searched for in a predetermined data format, information searching processing means for searching for desired information by having access to the searched information data base on the basis of the contents of the collected data information and searched information transmitting server for transmitting the obtained searching result by the transmission of an URL of a designated Web via an electric mail to the cellular phone terminal through an internet network in a predetermined format such as a characteristic information, an image, a voice or the like. In the voice searching system of the internet information for the cellular phone terminal according to the present invention, the information is capable of being received by clicking the URL of the Web.

Further, in the voice searching system of the internet information for the cellular phone terminal according to the present invention, the cellular phone terminal may comprise a cellular phone, a mobile computer or a car navigation system, which is capable of being connected to an internet. Alternatively, the information may be transmitted to a designated computer at home or the like from the searched information transmitting server, which transmits the electric mail and the URL of the Web via an electric mail. It is preferable that the orders such as the booking and a purchasing are capable of being accepted through the cellular phone terminal on the basis of the searched information from the searched information transmitting server, which is received at the cellular phone terminal. Also, an electronic settlement is capable of being carried out by a card, an internet banking or the like upon accepting the order.

In the case that the voice searching system of the internet information for the cellular phone terminal according to the present invention is configured as described above, the searched information may be collected by the voice recognition through a normal cellular phone line and the obtained searching result may be transmitted by the transmission of a mail or an URL of a Web via an electric mail to the cellular phone terminal through the internet network in a desired format such as a characteristic information, an image, avoice or the like. Therefore, a client is capable of receiving a required searching result through the internet in a predetermined format such as a characteristic information, an image, a voice or the like by simply inputting the required information with a voice according to the voice guide. As a result, the client can obtain the required information without any special skills.

A “cellular phone terminal” does not mean only a “cellular phone” in a general sense, however, it may include, for example, a communication terminal of a mobile computer, a car navigation system or the like, which is provided with both functions, i. e., a telephone function such as a PHS, a portable telephone next generation or the like and an internet function.

### BRIEF DESCRIPTION OF THE DRAWINGS

FIG. 1 is a block diagram for illustrating an embodiment according to the present invention;

FIG. 2 is a diagram for illustrating an example of a screen on which the searching result is displayed.

### DESCRIPTION OF THE PREFERRED EMBODIMENTS

An embodiment of the present invention will be described with reference to the drawings below.

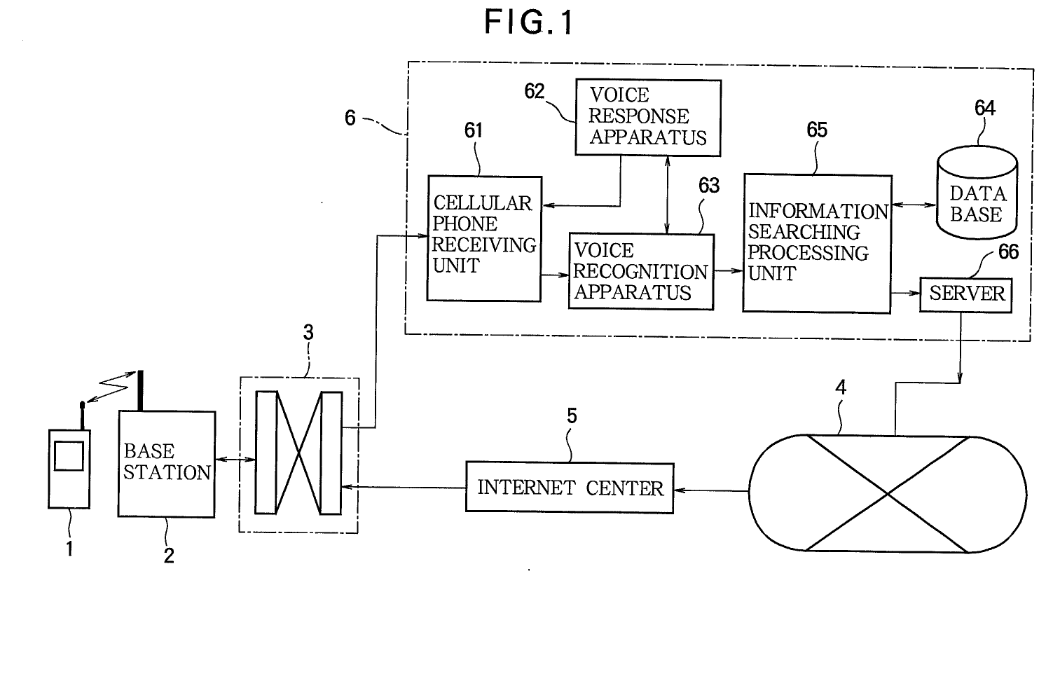

FIG. 1 is a diagram for illustrating an embodiment of a voice searching system for internet information for a cellular phone according to the present invention. The embodiment in FIG. 1 includes a cellular phone terminal 1 provided with an internet function, a base station for the cellular phone 2, a cellular phone telephone network 3, an internet network 4, an internet center 5 for connecting the cellular phone telephone network 3 and the internet network 4 and a voice searching system for internet information for a cellular phone 6 (hereinafter, be called “a voice searching system of an information” for short) according to the present invention, which is connected to the cellular phone telephone network 3 and the internet network 4.

As shown in FIG. 1, the voice searching system of the information 6 is composed of a cellular phone receiving unit 61 for obtaining the telephone number of a calling party of the cellular phone terminal 1 as well as receiving the telephone call from the cellular phone terminal 1 to be connected through the cellular phone telephone network 3, a voice response apparatus 62 for transmitting a guide voice by the voice to the cellular phone terminal 1, a voice recognition apparatus 63 for voice recognizing the voice phone call to be transmitted from the cellular phone terminal 1 and converting it to the data information, a searched information data base 64, which stores various information to be searched in a predetermined data format, an information searching processing unit 65 for searching a desired information by having access to the searched information data base 64 on the basis of the contents of the collected data information and a searched information transmitting server 66 for forming a mail address of the cellular phone terminal 1 on the basis of the obtained telephone number of the cellular phone and a domain of a cellular phone carrier as well as transmitting the obtained searching result at the information searching processing unit 65 by the transmission of a mail or an URL of a Web via an electric mail to the cellular phone terminal 1 through the internet network 4 in a desired format such as a characteristic information, an image, a voice or the like.

Alternatively, an electric mail address (for example, “09012345678@xxxxxx.ne.jp”),which is peculiar to the cellular phone terminal 1 which is obtained by combining the telephone number of the cellular phone terminal 1 (for example, “0901-234-5678”) and the domain of the carrier of the cellular phone terminal 1 (for example, “xxxxxx.ne.jp”), is given to the cellular phone terminal 1 provided with the internet function when the client purchased this cellular phone terminal 1.

Next, the searching operation of the cellular phone terminal 1 will be explained.

In the same way as the above described conventional case, taking an example such that an accommodation, which fits the demands, is searched by having access to the voice searching system of the internet information for the cellular phone 6 for reserving an inn and a hotel and information concerning the availability thereof, the operation thereof will be explained.

The client, who wishes to search the information by having access to the voice searching system of the information 6 from the cellular phone terminal 1, presses the dial buttons of the telephone number of the voice searching system of the information 6 on the cellular phone terminal 1 to make a phone call to the voice searching system of the information 6 via the base station for the cellular phone 2 and the cellular phone telephone network 3.

When the cellular phone receiving unit 61 of the voice searching system of the information 6 receives this telephone call, it connects the line to the voice response apparatus 62. Then, the voice response apparatus 62 collects the information, which is necessary for the information searching, by using the voice from the client, who placed a telephone call, while sequentially transmitting the guide message by using the voice as follows.

In other words, at first, for example, the voice response apparatus 62 transmits the voice guide message such as “Please tell a content you want to search for by voice” after transmitting the voice guide message such as “This is a voice searching site of NTT docomo. This site collects information, which is necessary for searching, by using your speaking voice. Please answer sequentially in accordance with the voice guide message”. The client, who listened to the message answers “hotel reservation”, for example, when one wishes to make hotel reservation.

The voice signal of “hotel reservation” is transmitted to the voice recognition apparatus 63 to be voice recognized there. Then, for confirmation, in accordance with its voice recognition result, a guide message such as “You wish to search the contents of hotel reservation. Then, please speak the conditions of search sequentially in accordance with the voice guide message” or the like is transmitted to the client. Alternatively, this voice recognition information of “hotel reservation” is transmitted to the information searching processing unit 65 to be stored in the storage means of the data base or the like.

Next, the voice response apparatus 62 forms the necessary guide messages according to the voice recognizing result, such as “Please tell your desired date of stay and a number of days of stay”, “Please tell the place you wishes to stay”, “Please tell your desired type of the rooms, for example, a single bedroom, a twin bedroom or a double bedroom” and “Please tell your desired accommodation charge” or the like by using the voice synthesis or the like to transmit them sequentially to the client.

The client who listened to the guide messages tells one's desired conditions sequentially, for example, “some date, one night”, “Minato-ku, Tokyo”, “a twin bedroom” and “not more than fifteen thousand yen for a night” or the like.

The answer voice of the client is transmitted to the voice recognition apparatus 63 on each occasion. Then, the data regarding the information of the answer voices of the client is collected by the voice recognition to be transmitted to the information searching processing unit 65 as well as to the voice response apparatus 62. Finally, it is stored in the storage means such as the data base or the like.

The voice response apparatus 62 provides a guide message by voice, for example, “Your desired date of stay is such and such a day of such and such month, the number of days of stay is one night, the place to stay is Minato-ku, Tokyo, the type of the room is a twin bedroom and the accommodation charge is not more than fifteen thousand yen for a night. Searching for such hotels, which satisfies your conditions among the resisted hotels, we will notice it to you later. Please hang up the phone andwait for our answer.”. The clientwho listenedto this guide message hangs up the cellular phone terminal 1 and waits for the answer.

The information searching processing unit 65 of the voice searching system of the information 6 has access to the searched information data base 64 and searches such hotel, which satisfies the searching conditions, which are collected sequentially in accordance with the guide message.

In the above example, the searching conditions collected by the client by using the voice recognition, are defined as follows.

| | |
|---|---|
| Condition 1: | date of stay = Xth of ----- |
| Condition 2: | number of days of stay = one night |
| Condition 3: | place of stay = Minato-ku, Tokyo |
| Condition 4: | type of the room = a twin bedroom |
| Condition 5: | accommodation charge = not more than fifteen |
| | thousand yen a night |

It is assumed that the following two hotels are searched for as hotels which satisfy these conditions and telephone numbers of these hotels are as follows.

1. hotel ABC

telephone number: 03-3456-xxxx

address: Minato-ku, xxxx

charge of twin room: ten thousand yen

2. hotel XYZ

telephone number: 03-3456-xxxx

address: Minato-ku, xxxx

charge of twin room: fifteen thousand yen

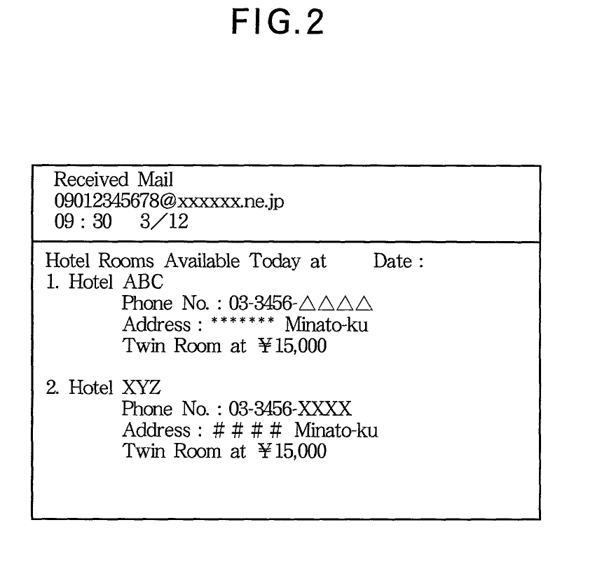

If the hotel which satisfies the conditions of the client is searched for in this way, the information searching processing unit 65 transmits its searching result to the searched information transmitting server 66. On the basis of this searched information result, the searched information transmitting server 66 writes an electric mail as illustrated in FIG. 2. Then, the searched information transmitting server 66 transmits this formed mail to the above described mail address “09012345678@xxxxxx.ne.jp” via the internet network 4 by an electric mail.

The electric mail transmitted to the internet network 4 is further transmitted to the internet center 5 in accordance with the mail address. Then, it is transmitted to the cellular phone terminal 1 via the cellular phone telephone network 3 and the base station for the cellular phone 2 to be displayed on the screen of the cellular phone terminal 1 as the electric mail shown in FIG. 2.

The client who receives the electric mail as shown in FIG. 2 selects the first hotel ABC or the hotel XYZ by scrolling the icon for selection and makes a hotel reservation by automatically making a phone call by use of the above described “phone to” function or the like. Although the illustration is omitted, in the case that the searched hotel manages the home page, the address of the home page (URL) is transmitted together with the telephone number to have access to the home pages of respective hotels by use of “web to” function or the like. Then, after confirming the content of the hotel on the home page, the client makes the hotel reservation by phone.

Thus, the voice searching system of the information according to the embodiment set forth to the present invention eliminates the need for selecting sequentially the items to be structurally displayed sequentially on the screen of the cellular phone terminal as the conventional searching system by the operation such as the icon scrolling or the like, so that it is possible to automatically receive the necessary searching result via the internet by the transmission of the electric mail and the URL of the Web in an electronic mail by simply inputting the necessary information by the voice sequentially in accordance with the voice guide.

According to the above described embodiment, the searching result is transmitted by the electric mail. Further, it is possible to attach the image information to this mail and at the same time, it is possible to attach the voice information thereto. Alternatively, the searched information data base 64 is always updated to the newest data by the data updating apparatus, which is not illustrated.

According to the above described embodiment, the searching result is transmitted to the client by an electric mail. However, the URL of the Web via the home page may be transmitted by the mail, so that the client is capable of seeing the information by having access to the URL of the Web.

In other words, in the case of transmitting the URL of the Web by the mail, after the searching conditions are completely collected, the voice response apparatus 62 provides a guide message by the voice, for example, “Your desired date of stay is Xth day of - - - , number of days of stay is one night, place to stay is Minato-ku, Tokyo, type of the room is a twin bedroom and accommodation charge is not more than fifteen thousand yen a night. Searching such hotels, which satisfies your conditions among the resisted hotels, we will notice it to you later. Please hang up the phone and wait for our answer.” or the like.

Then, the voice searching system of the information 6 transmits this searching result to the searched information transmitting server 66 when the above described hotel, which satisfies the conditions of the client, is searched for by the information searching processing unit 65. Then, the searched information transmitting server 66 transmits this searched information result to the cellular phone terminal 1, which is connected to the home page, by the transmission of the URL of the Web in the electric mail.

This URL of the Web, which is transmitted to the internet network 4, is transmitted to the cellular phone terminal 1 via the internet center 5 and the URL of the Web is displayed on the screen of the cellular phone terminal 1, so that the client is capable of receiving the information by clicking this URL of the Web.

The above described embodiment is explained with respect to the case of making a hotel reservation. However, this embodiment may be applied to all business transactions to be carried out at present through the internet, such as the purchase of the goods or like. In this case, it is possible to make an electronic settlement through a card such as a credit card and a bank card and an internet banking or the like. In the case of a card settlement, it is capable of being carried out by the operation of dial keys of the cellular phone terminal or the voice recognition.

Alternatively, the above described embodiment is explained with respect to the case that the information is seen on the mobile terminal such as a cellular phone, a mobile computer, a car navigation system or the like. However, the information may be transmitted to the URL (a computer at home or the like), which is registered, so that it can be seen on a large screen. In this case, the information may be transmitted with being enlarged.

According to the voice searching system of the internet information for the cellular phone terminal of the present invention, the searched information is collected by the voice recognition through a normal cellular phone line and the obtained searching result is transmitted by the transmission of the electric mail or the URL of the Web via an electric mail to the cellular phone terminal through the internet network in a desired format such as a characteristic information, an image and a voice or the like, so that a client is capable of receiving a required searching result through the internet by simply inputting the required information with a voice according to the voice guide easily without any special skills. As a result, compared to the conventional system, the operation becomes very simple. Alternatively, the present invention has an effect such that the procedure such as the reservation and the purchase can be carried out by the cellular phone terminal on the basis of the searching result from the server and the electronic settlement by the card or the like can be realized.

What is claimed is:

1. A voice searching system of an internet information for a cellular phone comprising:
cellular phone receiving means for receiving a telephone call from a cellular phone terminal to be connected through a cellular phone telephone network;
voice response means for transmitting a guide voice by a voice to the cellular phone terminal;
means for voice recognizing a voice phone call to be transmitted from the cellular phone and searching for a desired data information;
a searched information data base, which stores various information to be searched for in a predetermined data format;
information searching processing means for searching for desired information by having access to the searched information data base on the basis of a contents of collected data information; and;
searched information transmitting server for automatically transmitting the obtained searching result to the cellular phone terminal through an internet network via an electric mail in a predetermined format such as characteristic information, an image and a voice or the like.

2. A voice searching system of internet information for a cellular phone comprising:
cellular phone receiving means for receiving a telephone call from a cellular phone terminal to be connected through a cellular phone telephone network;
voice response means for transmitting a guide voice by a voice to the cellular phone terminal;
means for voice recognizing a voice phone call to be transmitted from the cellular phone terminal and searching for desired data information;
a searched information data base, , which stores various information to be searched in a predetermined data format;
information searching processing means for searching a desired information by having access to the searched information data base on the basis of contents of the collected data information; and
searched information transmitting server for transmitting the obtained searching result by the transmission of an URL of a designated Web via an electric mail to the cellular phone terminal through an internet network in a predetermined format such as characteristic information, an image and a voice or the like;
wherein the information is capable of being received by clicking the URL of the Web.

3. A voice searching system of internet information for a cellular phone according to claim 1 or claim 2; wherein the cellular phone terminal comprises a cellular phone, a mobile computer or a car navigation system, which is capable of being connected to an internet.

4. A voice searching system of an internet information for a cellular phone according to claim 1 or claim 2; wherein the information is transmitted to a designated computer at home or the like from the searched information transmitting server, which transmits the electric mail and the URL of the Web via an electric mail.

5. A voice searching system of internet information for a cellular phone according to claims 1 to 4; wherein orders such as the booking and the purchasing are capable of being accepted through the cellular phone terminal on the basis of the searched information from the searched information transmitting server, which is received at the cellular phone terminal.

6. A voice searching system of internet information for a cellular phone according to claim 5; wherein an electronic settlement is capable of being carried out by a card, an internet banking or the like upon accepting the order.
